(19) United States
(12) Patent Application Publication
(10) Pub. No.: US 2021/0340871 A1
(43) Pub. Date: Nov. 4, 2021

(54) NOVEL TUNNEL FORMING SHANKS AND METHODS OF USING

(71) Applicant: Seamless AG Works LLC, Christmas Valley, OR (US)

(72) Inventor: Stanley L. ADAMS, Christmas Valley, OR (US)

(73) Assignee: Seamless AG Works LLC, Christmas Valley, OR (US)

(21) Appl. No.: 16/863,913

(22) Filed: Apr. 30, 2020

(51) Int. Cl. E21D 9/00; E21D 9/04

(52) U.S. Cl. CPC E21D 9/005; A01M 17/004; E21D 9/04

(57) ABSTRACT

Disclosed herein are new tunnel forming shanks and methods of using the same that are configured to lessen the damage done to soil and crops, and to overcome underground obstacles in comparison to prior art tunnel forming shanks.

### FIELD OF THE INVENTION

The invention pertains to the field of underground tunnel formation. More specifically, the teachings herein relate to an improved shank, attached to a towable implement or a self-motorized implement, wherein the shank is configured to create underground tunnels when the shank moves forward, such as when pulled by a motorized vehicle.

### BACKGROUND

Implements having shanks and that are towable by tractors are currently used for underground tunnel formation. See U.S. Pat. No. 8,567,113 (Pask et al.) The resulting subterranean channels can be suitable for multiple uses, non-exclusively including laying poisonous bait for burrowing agricultural pests, such as gophers, or for laying underground cable or tubing. Using a towable implement with toxic bait has the potential to be a much cheaper and efficient way to kill burrowing pests compared to setting multiple traps or hiring professional exterminators.

The problem with existing shanks is that they can cause serious damage to the soil and/or crop, especially forage crops such as grass or alfalfa. Pask et al. shows a typical design of an existing shank (ref no. 20), where there is an acute angle between the underside of the torpedo tube (ref no. 22) and the bottom leading edge of shank (ref no. 20). This acute angle aggressively collects the roots of forage crops, such as grass and alfalfa, and destroys them and also creates a significant and usually unrepairable damage to the soil. Additional prior art shanks are shown in FIGS. 3A and 3B. Thus, a grass or alfalfa farmer is currently left with a difficult choice between either using expensive, time-consuming methods of vermin extermination or damaging the soil and/or crop in the process of trying to eradicate the burrowing pests using existing shanks on trailers.

Accordingly, there is a need in the art to provide new towable shanks that allow users to ameliorate the damage done to soil and crops when creating underground tunnels, such as those suitable for laying poisonous bait for burrowing animals.

Various aspects of the invention are enumerated in the following paragraphs. Preferred embodiments are directed to a tunnel creating implement comprising: a frame having front and rear ends along a longitudinal axis; a shank, coupled to the frame, and having a leading edge that faces towards the front end of the frame with upper and lower termini, where the upper terminus is positioned forward of the lower terminus; and wherein the leading edge is configured to cut through ground when the frame is moving in a forward direction; and a tube configured for creating underground tunnels, having a front end, a back end, a topside, and an underside, wherein the tube is operably coupled to the shank such that the front end of the tube does not extend forward past the lower terminus of the leading edge and the angle between the underside of the tube and the lower terminus of the leading edge of the shank is obtuse.

Further embodiments include an implement that weighs at least 1,000 lbs. Further embodiments include an implement comprising one or more counterweights, weighing a total of between 1,000-3,000 lbs, that are positioned forward of the shank. Further embodiments include an implement further comprising a yoke positioned in front of the shank and is configured to operably couple with a towing vehicle. Further embodiments include an implement further comprising one or more counterweights, weighing a total of between 1,000-3,000 lbs, that are positioned forward of the shank on the yoke. Further embodiments include an implement wherein the one or more counterweights comprise one or more boxes filled with a material selected from the group consisting of: rock, concrete, and metal. Further embodiments include an implement that lacks a coulter positioned forward of the shank on the longitudinal axis. Additional embodiments include an implement further comprising a hopper configured to hold bait, wherein the hopper is in operable communication with the tube, such that bait can travel from the hopper into the tube and out an opening in the tube and into a tunnel formed by the tube. Additional embodiments include an implement wherein the shank has a hollow channel in operable communication with the tube and the hopper, and is configured to allow bait to drop into the tube from the hopper. Additional embodiments include an implement further comprising a spool configured to hold cable or flexible tubing, wherein the spool is in operable communication with the tube, such that cable or flexible tubing can travel from the spool into the tube and out an opening in the tube and into a tunnel formed by the tube. Additional embodiments include an implement wherein the shank has a hollow channel in operable communication with the tube and the spool, and is configured to allow the cable or flexible tubing to drop into the tube from the spool. Additional embodiments include an implement wherein the shank lacks a tip or other extension that is adjacent to the lower terminus of the leading edge and extends forwards past the lower terminus.

Further embodiments are directed to methods of creating an underground tunnel comprising: providing a tunnel creating implement comprising: a frame having front and rear ends along a longitudinal axis; a shank, coupled to the frame, and having a leading edge that faces towards the front end of the frame with upper and lower termini, where the upper terminus is positioned forward of the lower terminus; and wherein the leading edge is configured to cut through ground when the frame is moving in a forward direction; and a tube configured for creating underground tunnels, having a front end, a back end, a topside, and an underside, wherein the tube is operably coupled to the shank such that the front end of the tube does not extend forward past the lower terminus of the leading edge and the angle between the underside of the tube and the lower terminus of the leading edge of the shank is obtuse; and moving the tunnel forming implement in a forward direction wherein the shank cuts through ground and the tube forms a tunnel underground.

Additional embodiments include methods of tunnel creation wherein the tunnel forming implement further comprises one or more counterweights, weighing a total of between 1,000-3,000 lbs, that are positioned forward of the shank. Additional embodiments include methods of tunnel creation wherein the tunnel creating implement further comprises a yoke positioned in front of the shank and is configured to operably couple with a towing vehicle, and the tunnel is formed as the implement is towed forward. Additional embodiments include methods of tunnel creation wherein the tunnel creating implement further comprises one or more counterweights, weighing a total of between 1,000-3,000 lbs, that are positioned forward of the shank on the yoke. Additional embodiments include methods of tunnel creation wherein the tunnel creating implement further comprises a hopper configured to hold bait, wherein the hopper is in operable communication with the tube, such that bait travels from the hopper into the tube and out an opening in the tube and into the tunnel formed by the tube. Additional embodiments include methods of tunnel creation wherein the tunnel creating implement further comprises a spool configured to hold cable or flexible tubing, wherein the spool is in operable communication with the tube, such that cable or flexible tubing travels from the spool into the tube and out an opening in the tube and into a tunnel formed by the tube. Additional embodiments include methods of tunnel creation wherein the tunnel is being formed in a crop plot, such as a forage crop.

### BRIEF DESCRIPTION OF THE FIGURES

FIG. 1A is a side view of a shank and tube.

FIG. 1B is an exploded view of the shank and tube.

FIG. 2 is a side view of an implement with shank and hopper.

FIG. 3A is a side view of a prior art implement with shank.

FIG. 3B is a side view of a prior art shank.

FIG. 4 is a perspective view of the implement, shank, and weight boxes.

FIG. 5 is a side view of the implement with shank and spool.

### DETAILED DESCRIPTION OF THE INVENTION

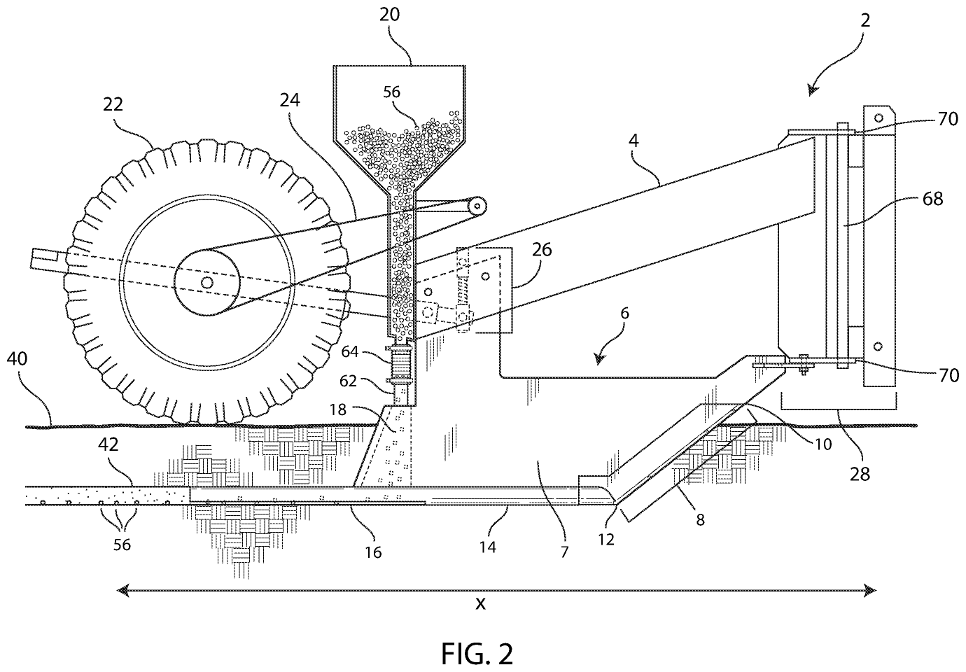

FIG. 2. depicts a preferred towable implement 2 having a frame 4 with forward and rear ends along a longitudinal axis (x) with a yoke 28 configured to operably couple with a towing vehicle at the forward end and a wheel 22 near or at the rear end. While the majority of embodiments herein refer to a towable implement, non-preferred embodiments encompass the implement 2 being motorized and self-steering (e.g., having a steering wheel and one or more front wheels in front of the shank) or non-releasably coupled to a suitable vehicle that is motorized and self-steering. According to these non-preferred embodiments, the yoke 28 can be absent or modified accordingly.

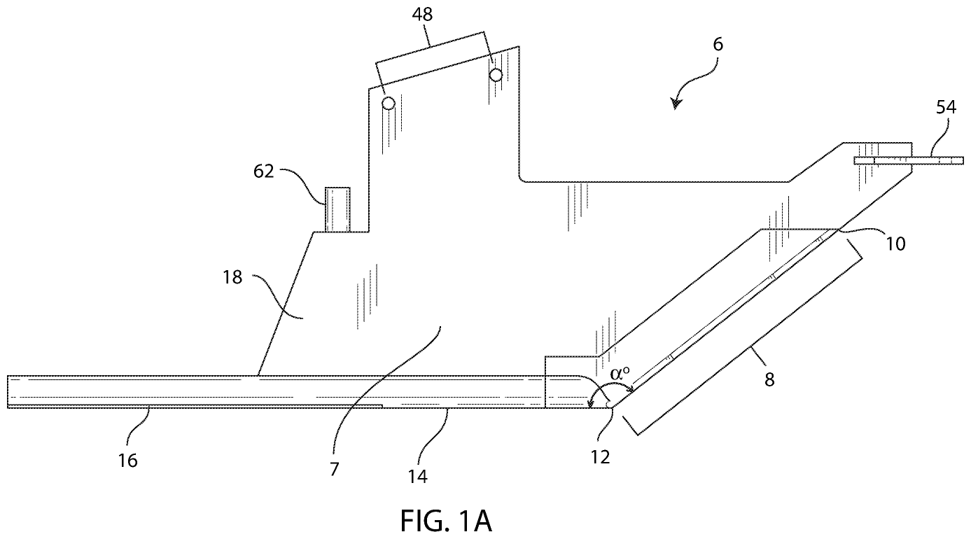

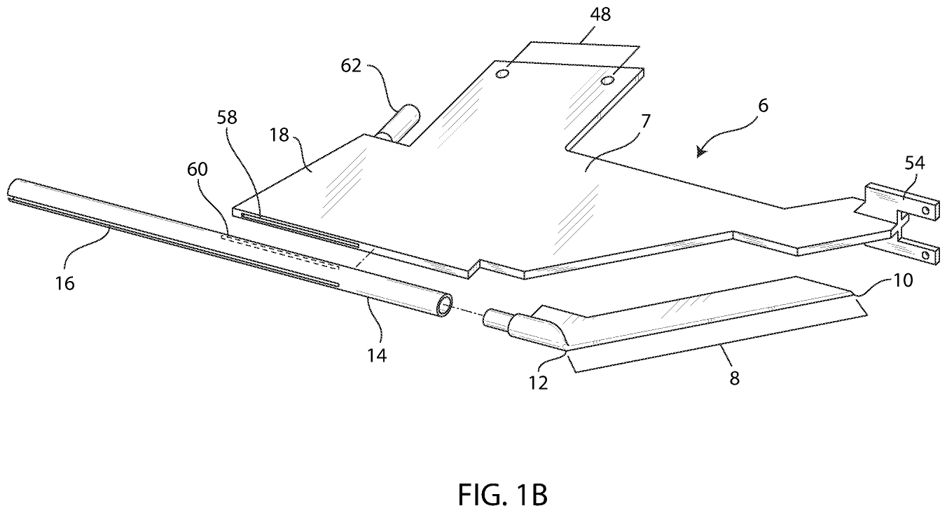

FIG. 1A depicts a tube 14 and a shank 6 assembly. Wherein the shank 6 comprises a main body 7 and a leading edge 8 that faces the towing vehicle and comprises an upper terminus 10 and a lower terminus 12 and is configured to cut through the ground. The upper terminus 10 is positioned forward of the lower terminus 12. The shank 6 is operably coupled to and positioned below the frame 4.

The tube 14 is operably coupled to and preferably positioned below the shank 6 and comprises a front end, a back end, a topside, and an underside. According to preferred embodiments herein, the tube 14 is positioned such that its front end does not extend forward past the lower terminus 12 of the leading edge 8 and the angle α between the underside of the tube 14 and the lower terminus 12 of the leading edge 8 of the shank 6 is obtuse. More preferably, the angle α can be between 175°-95°. Still more preferably, the angle α is between 113°-143°, and still more preferably the angle is about 128°.

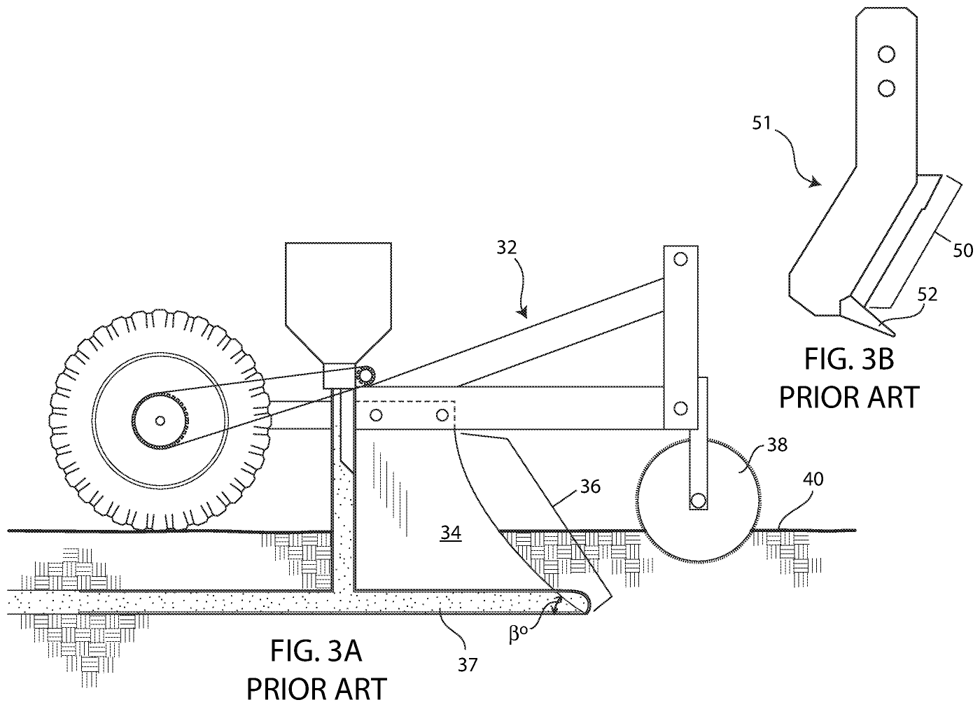

The forward angle (from the lower terminus 12 to the upper terminus 10) of the shank's leading edge 8 provides significant advantages over prior art shanks 34 such as shown in FIG. 3A. Prior art shanks 34 generally have a leading edge 36 that angles backwards from the lower terminus to the upper terminus, creating an acute angle β between the underside of the tube and lower terminus of the leading edge 36. Additionally, the front ends of prior art tubes 37 often extend forward past the lower terminus of their shank's 34 leading edge (as shown in FIG. 3A). Another prior art shank 51 is shown in FIG. 3B and includes a tip 52 that extends forward, past the lower terminus of the leading edge 50. It is not believed this shank 51 is used with a tube for tunnel forming. The shanks 34 and 51 shown in FIGS. 3A and 3B, and similar prior art designs, are not “self-cleaning”, meaning that they catch unwanted substances below ground on one or more of the following: their backward-angled (from the lower terminus to the upper terminus) leading edges 36, the forwardly extended tubes 37 or forwardly extended tips 52.

These prior art designs cause substantial upheaval of soil and/or crop material, such as the roots of grass crops and other forage crops, such as alfalfa. This results in significant financial loss to the plot owner. To try and ameliorate these undesirable results, prior art implements 32 include a coulter disc 38 which is positioned ahead of the shank 6 and configured to cut roots and debris beforehand. In contrast, the forward-angled (from lower terminus to upper terminus) leading edges 8 of the shanks 6 provided herein are “self-cleaning” as they are towed forward, such that the crop and soil materials are more likely slide down and off the leading edge 8 without getting caught up in a backward angled leading edge 36, or point/tip 52, or tube 37 that extends past the lower terminus of the leading edge. According to preferred embodiments a coulter 38 is not used with the implements herein. Thus, the teachings provided herein are useful on forage crops such as alfalfa or grass, or other suitable plots and crops. The teachings are also useful on any type of area where the user desires to create underground tunnels without significantly tearing up the ground, such as a golf course.

Another disadvantage to prior art shanks, such as 34, is that they hit hard underground obstacles, such as rocks with significant direct force, as the backward-angle design is not configured to go over the obstacle. In contrast, the forward-angle shanks 6 described herein, allow the leading edge 8 to glide over hard underground obstacles, lessening the impact force, and thereby ameliorating the damage incurred to the shank 6 and the implement 2.

While the leading edge 8 is shown in FIGS. 1A and 1B as a straight forward-angled line connecting the lower terminus 12 and the upper terminus 10, the leading edge 8 can also be curvilinear, such as convex or concave, similar to 34 but wherein the upper terminus is positioned more forward than the lower terminus.

Preferred shanks 6 can be constructed using any suitable material or method, such that they are strong enough to withstand the forces associated with being towed underground to cut through soil and encounter underground obstacles, such as rocks. Accordingly, preferred manufacturing materials are metals, such as steel. While not being limited to a certain thickness, it is preferred that the shanks 6 provided herein are between about ¼″ to 2″ thick, more preferably about ¾″, thick as measured from its left to right side. According to preferred embodiments, the leading edge 8 is hardened to make cutting through the ground easier. While the shank 6 can be made as one piece, it is preferred that it is constructed from at least two different pieces with the shank body 7 and the hardened leading edge 8, as shown in FIG. 1B

While the shank 6 can be coupled to the frame 4 using any suitable way, according to preferred embodiments, bolts are secured through holes 48 to the frame 4. Additionally, a front extension 54 can be coupled to the yoke 28 for additional stability. Preferred front extensions 54 include two attachment points, one on each side of the shank 6.

When not in use, the shank 6 can be resting on top of the ground 40 in its natural resting position. Any suitable mechanism can be used to initially lower the shank 6 into the ground 40 when beginning to form tunnels 42 or to raise the shank 6 above ground 40 when tunnel formation has finished. According to preferred methods, a 3-point hitch operably coupled to the yoke 28 on one end and a motorized vehicle, such as a tractor, on the other end, can be utilized to raise and lower the shank 6 out of and into the ground. The raising and lowering mechanism can be operated manually, electronically, and/or remote controlled, such as from a driver's seat in a tractor.

A height adjustment mechanism 26 positioned on the frame 4 can be utilized to preset the height of the shank 6 when it is underground, allowing for lower and higher tunnels depending on the goals of the user. Any suitable height adjustment mechanism 26 can be utilized with the teachings herein, non-exclusively including cranks, adjustable bolts within threads, and hydraulics for example. The height adjustment element can be configured to either allow intermittent or continuous height adjustment of the shank 6. The height adjustment mechanism 26 can be operated manually, electronically, and/or remote controlled, such as from the driver's seat in the tractor.

According to preferred embodiments, a tube 14 configured for creating underground tunnels 42 is positioned below the shank 6 and includes a front end, a back end, a topside, and an underside. According to preferred embodiments, the front end of the tube 14 does not extend forward past the lower terminus 12 of the leading edge 8 and the a angle between the underside of the of tube 14 and the lower terminus 12 of the leading edge of the shank 6 is obtuse. The front and back ends of the tube 14 can be either open and/or closed, but it is preferred the front end of the tube 14 is closed such that soil cannot enter while the back end is open. The tube 14 can be made of any suitable material for withstanding the pressures of being towed underground, and is thus preferably made of metal, such as steel, but could conceivably be made of other rigid materials such as hard plastic in non-preferred embodiments. The diameter of the tube 14 can be configured by the user to whatever desired diameter the user desires the created tunnels 42 to be. This can depend on the purpose of the tunnel, whether for gopher extermination, laying cable, or flexible tubing, such as irrigation tubing. For example, the tube 14 can non-exclusively have a diameter of between ¾″ and 6″, but is preferably between 2-3″, such as 2⅜″. According to non-preferred embodiments, the tube can be positioned behind the shank, instead of below, such that the front end of the tube abuts against the backside of the shank (not shown) as opposed to being adjacent to the lower terminus 12 of the leading edge 8. Under this configuration, the underside of the tube can be aligned with the bottom side of the shank and/or is approximately parallel to the ground level, and the hollow channel can be modified to open into the tube.

Preferably, at least one wheel 22 is positioned at or near the rear end of the frame 2 and is configured to roll on top of the ground 40 as the implement 2 is being towed, or otherwise moved in a forward direction. The wheel 22 is advantageous in that it helps pack the ground on the cut the shank 6 creates on top of the ground 40 as its leading edge 8 moves through the soil. Accordingly, it is preferred that a wheel 22 is aligned (centered) with the shank 6 and is sufficiently heavy and wide enough is so that it packs dirt onto the above ground cut created by the leading edge 8. A wheel 22 is also advantageous in that in can be coupled to a metering mechanism for a hopper 20, such as through a chain drive 24 with sprockets, which is discussed in more detail below. While a wheel 22 is preferred, other embodiments could potentially utilize other members for allowing the implement to move forward on the ground 40, non-exclusively skis or tracks.

For embodiments directed to the use of poisonous bait, the implement 2 preferably include a hopper 20 in operable communication with the shank 6 and tube 14. According to preferred embodiments, the hopper 20 holds poisonous bait, such as pellets, and couples to a hose 64 which in turn couples to a connection point 62 above a hollow channel 18 in the shank 6. While the hose 64 is preferably made of a flexible material, such as, corrugated plastic tubing, rubber, or nylon, it can also be made of a rigid material, such as PVC, or metal. The hollow channel 18 is operably coupled to the tube 14 to allow bait 56 to travel through, and preferably includes a lower slit 58 at the bottom of the hollow channel, that is aligned to an upper slit 60 on the tube 14. The bait 56 then falls out of the lower slit 16 in the tube 14 into the created tunnel 42. Alternatively, the bait 56 can fall out an opening at the back end of the tube 14 or through one or more holes on the underside of the tube. Any suitable space on the implement 2 can be utilized to position the hopper 20, such as behind or in front the shank 6, in addition to above the shank, like the position shown in FIG. 2.

Other configurations envisioned in the description herein include those where the hopper is in operable communication with the tube by bypassing the shank, such that the hollow channel isn't used. As a non-exclusive example a user could attach a hose from the hopper directly to the tube (not shown).

Any suitable type of metering mechanism for controlling the amount of bait 56 to be released can be used with the hopper 20. Metering mechanisms can be configured to open and close the hopper 20 thereby allowing a determined amount of bait 56 to drop into the hose 64 and eventually the tube 14. As one preferred example of a metering mechanism, a chain drive can be used. More specifically, a wheel chain 24 can be coupled to the wheel 22 such that as the wheel 22 rolls forward during towing or advancement of the implement 2, the chain 24 revolves around a pair of sprockets thereby opening the underside the hopper 20 which releases the bait 56 down the hose 64 and into the tube 14 at a desired amount and rate. In additional embodiments, the metering mechanism can be partially or completely controlled through other mechanical devices or electronically, such as a through an electronic interface near the driver's seat in the tractor or other motorized vehicle.

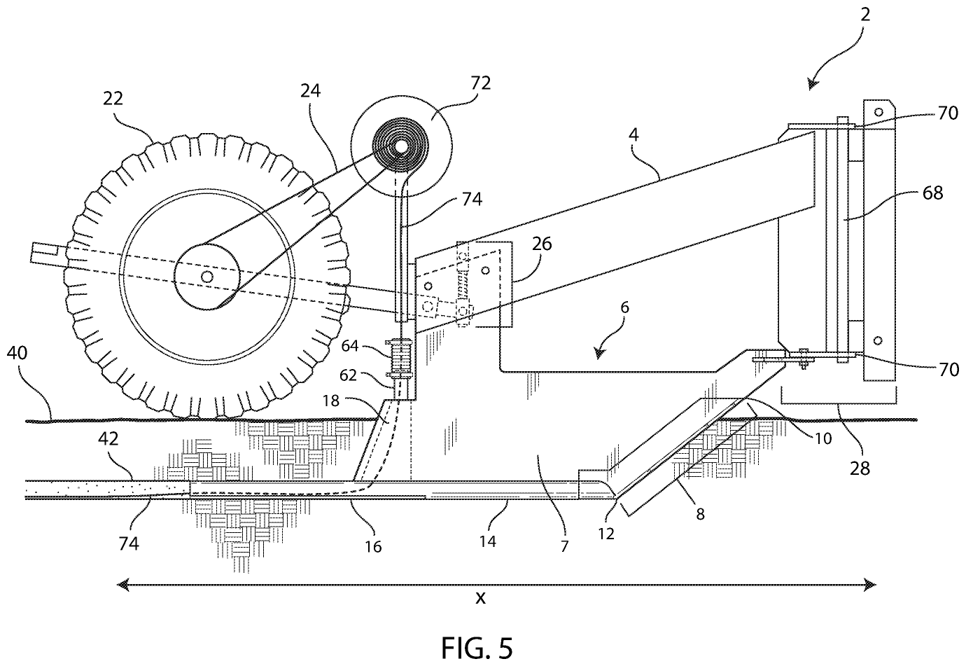

For embodiments directed to laying cable, or flexible tubing, a spool 72 wrapped with cable/flexible tubing 74 can be positioned on the implement 2, such as shown in FIG. 5, and configured to allow the cable/flexible tubing 74 to unravel as the implement 2 is towed or otherwise moved forward, such that the cable travels through the hollow channel 18 of the shank 6 into the tube 14 below utilizing gravity and similar to the way the bait 56 travels. The tube 14 can either utilize the lower slit 16 or the cable 74 can be laid out a back opening of the tube 14.

According to certain embodiments, the rotation of the spool 72 can be controlled using any suitable mechanism, such as being operably coupled to the wheel chain 24 such that it unravels as the wheel 22 travels forward. In other embodiments, the spool 72 can also be controlled through other mechanical devices or electronically, such as a through an electronic interface near the driver's seat in the tractor or other motorized vehicle. Cable can non-exclusively include, fiber optic cable, or other cables for transmitting electrical data or current. Flexible tubing can non-exclusively include tubes used for irrigation such as for golf courses or agriculture. Any suitable space on the implement 2 can be utilized to position the spool 72, such as behind or in front the shank 6, in addition to above the shank, like the position shown in FIG. 5. Other configurations envisioned in the description herein include those where the spool is in operable communication with the tube by bypassing the shank, wherein the hollow channel isn't necessary, such as by utilizing a hose from the spool to the tube (not shown).

For embodiments where the user merely wants to create a tunnel 42, without laying bait or flexible tubing/cable, a rigid tube without slots or holes on its underside can be utilized. Additionally, these embodiments would not require a metering mechanism/chain 24, hopper 20, spool 72, hose 64, hollow channel 18, slit 58 at the bottom of the hollow channel, upper slit 60 on the tube 14, or lower slit 16 on the underside of the tube 14. For these embodiments, the shank 6 and/or the tube 14 can optionally be solid throughout without hollow space.

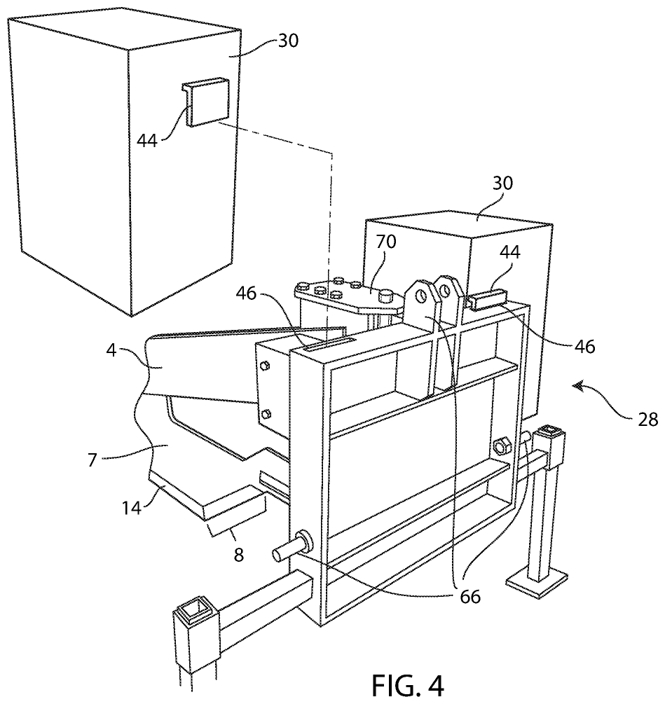

A yoke 28 is optimally positioned at the forward end of the frame 4 and is configured to operably couple and decouple to a tractor or other motorized vehicle with sufficient power to tow the full weight of the implement 2 in a forward direction. FIG. 2 shows a partial side view of a yoke 28 and FIG. 4 provides a detailed depiction of the front face of the yoke 28. According to preferred embodiments, the yoke 28 is configured to couple to a suitable hitch, such as a 3-point hitch or drawbar hitch, which in turns couples to the back end of the towing vehicle, such as a tractor with sufficient power to tow the implement 2. FIG. 4 depicts a preferred 3-point yoke wherein the yoke 28 is configured to couple to a 3-point hitch at attachment points 66.

The yoke 28 can preferably include one or more mechanisms to allow the frame 4 to oscillate laterally to facilitate alignment when creating the underground tunnel 42 and allow for easier turning. According to preferred embodiments, a pivot shaft 68 that traverses vertically or perpendicular in relation to the x-axis of the frame 4 is utilized. Advantageously, the pivot shaft 68 can be positioned between one or more plates 70 that act as bearing surfaces for the rotational pivot 68 movement.

The forward angle of the shanks 6 described herein generally require more weight in the implement 2 to keep the shank 6 below ground compared to prior art backward-angled shanks. Accordingly, it is preferred that the implements 2 provided herein include counterbalances to do so, such as when working with soil having normal or heavy density. These counterbalances are preferably positioned forward on the frame 4 along the x-axis compared to the shank 6 but could non-preferably be positioned above them as well. Positioning counterbalances behind the shank 6 is disadvantageous and would not work to keep the shank 6 below ground 40 during towing. As a non-limiting example of a counterbalance, one or more weight boxes 30 can be operably coupled to the yoke 28 in front of the shank 6. These weight boxes 30 can be filled with any heavy material the user desires, such as gravel, concrete, or metal. While the weight boxes 30 can be coupled to the yoke 28 using any suitable mechanism, they preferably include hooks 44 that slide into pockets 46 on the yoke 28. Alternatively, weight boxes 30 or other counterbalances could also be attached to the frame 4 instead of the yoke 28, preferably in front of the shank 6.

According to rare embodiments wherein the soil is extremely soft and loose, the weight of the implement 2 (particularly implements weighing more than 1000 lbs) may be sufficient to keep the shank 6 underground without the need of counterbalances (e.g., weight boxes 30). FIG. 2. depicts the implement 2 without counterbalances 30, and FIG. 4 shows the counterbalances 30 on the yoke 28.

Accordingly, preferred implements 2 with or without counterbalances weigh at least 1,000 lbs, still more preferably preferred implements without counterbalances weigh approximately between 1,600-2,400 lbs, or about 2,000 lbs. The counterbalances preferably weigh between 1,000-3,000 lbs, thus the total weight of a preferred implement 2 and counterbalance is between 2,600-5,400 lbs, more preferably 3,400-4,200 lbs, and still more preferably about 3,700-3,900 lbs.

1. A tunnel creating implement comprising:
a frame having front and rear ends along a longitudinal axis;
a shank, coupled to the frame, and having a leading edge that faces towards the front end of the frame with upper and lower termini, where the upper terminus is positioned forward of the lower terminus; and wherein the leading edge is configured to cut through the ground when the frame is moving in a forward direction; wherein the implement comprises one or more counterweights having a fixed weight, positioned either directly above or in front of the leading edge of the shank with respect to the frame; and
a tube configured for creating an underground tunnel, having a front end, a back end, a topside, and an underside, wherein the tube is operably coupled to the shank such that the front end of the tube does not extend forward past the lower terminus of the leading edge, defining an angle between the underside of the tube and the lower terminus of the leading edge of the shank that is obtuse.

2. The tunnel creating implement of claim 1, wherein the implement weighs at least 1,000 lbs.

3. The tunnel creating implement of claim 1, wherein the one or more counterweights weighs a total of between 1,000-3,000 lbs.

4. The tunnel creating implement of claim 1, further comprising a yoke, coupled to the frame and positioned in front of the shank, and is configured to operably couple with a towing vehicle, and wherein the one or more counterweights, weighing a total of between 1,000-3,000 lbs is positioned on the yoke.

5. (canceled)

6. The tunnel creating implement of claim 1, wherein the one or more counterweights comprise one or more boxes filled with a material selected from the group consisting of: rock, concrete, and metal.

7. The tunnel creating implement of claim 1, wherein the implement lacks a coulter positioned forward of the shank on the longitudinal axis.

8. The tunnel creating implement of claim 1, further comprising a hopper configured to hold bait, wherein the hopper is in operable communication with the tube, such that the bait can travel from the hopper into the tube and out an opening in the tube and into a tunnel formed by the tube.

9. (canceled)

10. The tunnel creating implement of claim 1, further comprising a spool configured to hold cable or flexible tubing, wherein the spool is in operable communication with the tube, such that cable or flexible tubing can travel from the spool into the tube and out an opening in the tube and into a tunnel formed by the tube.

11. The tunnel creating implement of claim 1, wherein the shank has a hollow channel in operable communication with the tube and the spool, and is configured to allow the cable or flexible tubing to drop into the tube from the spool.

12. The tunnel creating implement of claim 1, wherein the shank lacks a tip or other extension that is adjacent to the lower terminus of the leading edge and extends forwards past the lower terminus.

13. A method of creating an underground tunnel comprising:
providing a tunnel creating implement comprising:
a frame having front and rear ends along a longitudinal axis;
a shank, coupled to the frame, and having a leading edge that faces towards the front end of the frame with upper and lower termini, where the upper terminus is positioned forward of the lower terminus; and wherein the leading edge is configured to cut through the ground when the frame is moving in a forward direction; wherein the implement comprises one or more counterweights having a fixed weight, positioned either directly above or in front of the leading edge of the shank with respect to the frame; and
a tube configured for creating an underground tunnel, having a front end, a back end, a topside, and an underside, wherein the tube is operably coupled to the shank such that the front end of the tube does not extend forward past the lower terminus of the leading edge, defining an angle between the underside of the tube and the lower terminus of the leading edge of the shank that is obtuse; and
moving the tunnel forming implement in a forward direction wherein the shank cuts through ground and the tube forms the tunnel underground.

14. The method of claim 13, wherein the one or more counterweights, weighing a total of between 1,000-3,000 lbs, that are positioned forward of the shank.

15. The method of claim 13, wherein the tunnel creating implement further comprises a yoke positioned in front of the shank and is configured to operably couple with a towing vehicle, and the tunnel is formed as the implement is towed forward.

16. The method of claim 15, wherein the tunnel creating implement further comprises one or more counterweights, weighing a total of between 1,000-3,000 lbs, that are positioned forward of the shank on the yoke.

17. The method of claim 13, wherein the tunnel creating implement further comprises a hopper configured to hold bait, wherein the hopper is in operable communication with the tube, such that the bait travels from the hopper into the tube and out an opening in the tube and into the tunnel formed by the tube.

18. The method of claim 13, wherein the tunnel creating implement further comprises a spool configured to hold cable or flexible tubing, wherein the spool is in operable communication with the tube, such that the cable or flexible tubing travels from the spool into the tube and out an opening in the tube and into the tunnel formed by the tube.

19. The method of claim 13, wherein the tunnel is being formed in a crop plot.

20. The method of claim 19, wherein the crop plot comprises a forage crop.

21. The tunnel creating implement of claim 1, further comprising a tractor coupled to the frame, wherein the one or more counterweights having a fixed weight, is positioned in front of the leading edge of the shank with respect to the frame.

22. The method of claim 13, wherein the one or more counterweights having a fixed weight, is positioned in front of the leading edge of the shank with respect to the frame, and further comprising coupling the implement to a tractor.
